(19) United States
(12) Patent Application Publication
(10) Pub. No.: US 2008/0224896 A1
(43) Pub. Date: Sep. 18, 2008

(54) RADIOS, SYSTEMS, AND METHOD FOR PROVIDING REAL-TIME INFORMATION ABOUT USER-DEFINED GEOGRAPHIC LOCATIONS

(75) Inventor: Patrik Lundblad, Troy, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/684,653

(22) Filed: Mar. 12, 2007

(51) Int. Cl. G08G 1/123

(52) U.S. Cl. 340/989

(57) ABSTRACT

Radios, systems, and methods for providing real-time information about user-defined geographic locations are disclosed. One radio includes memory configured to store a data file representing a geographic location(s) defined by a user, and a receiver configured to receive signals including real-time information about a plurality of geographic locations. A processor is included to compare each of the plurality of geographic locations to the user-defined geographic location(s), and the information about the user-defined geographic locations is provided to the user. A system includes a computing device to create a data file of user-defined geographic locations, and transmit the data file to the radio. One method includes storing user-defined geographic location(s) in memory and receiving signals including information about a plurality of geographic locations. Each of the plurality of geographic locations is compared with the user-defined geographic location(s), and the user is presented with the information about the user-defined geographic location(s).

### FIELD OF THE INVENTION

The present invention generally relates to radios, and more particularly relates to radios, systems, and methods for providing real-time information about user-defined geographic locations.

### BACKGROUND OF THE INVENTION

A vehicle navigation system generally provides a user with his/her present geographic location and details of the surrounding area on a map. Typically, the navigation system receives its current position via, for example, global positioning. As the vehicle travels, the navigation system continually updates the current geographic location and surrounding area information.

Some navigation systems also include a feature that enables the user to view real-time conditions (e.g., traffic conditions) for its current geographic location and the surrounding area. To accomplish this, the navigation system receives signals that include information for geographic locations throughout an entire continent (e.g., North America and Europe), country, or state. After receipt of the signals, the navigation system matches the geographic locations in the signals with corresponding geographic locations stored in its database. After each geographic location is matched, the navigation system then selects and displays geographic locations within a pre-determined radius of its current position, as defined by its global positioning system (GPS). The navigation system then displays the traffic conditions for the GPS-defined geographic locations on the map.

Since navigation systems are capable of providing traffic conditions for geographic locations across an entire continent, country, or state, navigation systems require a large amount of memory, which increases the cost of the navigation system. Moreover, inclusion of a display providing a detailed map of the current location and surrounding area also increases cost, as does any necessary license fees for software and/or hardware components included in the navigation system. Accordingly, it is desirable to provide a more cost-efficient radio, system, and method for providing real-time information about geographic locations defined by the user. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Various exemplary embodiments of the invention include radios, systems, and methods for providing real-time information about user-defined geographic locations. One radio includes a memory configured to store a data file representing at least one geographic location defined by a user, and a receiver configured to receive signals including real-time information about a plurality of geographic locations. A processor coupled to the memory and the receiver is also included, and the processor is configured to compare each of the plurality of geographic locations to the at least one geographic location. The radio also includes a communication device that conveys information about the at least one geographic location to the user.

A system for providing real-time information about user-defined locations includes a computing device configured to receive and store data from a user in a data file defining at least one geographic location and a radio configured to receive the data file defining the at least one geographic location. The radio includes a memory configured to store the data file and a receiver configured to receive signals including real-time information about a plurality of geographic locations. The radio also includes a processor coupled to the memory and the receiver, and configured to compare each of the plurality of geographic locations to the at least one geographic location in the data file. Moreover, the radio includes a communication device that conveys information about the least one geographic location to the user.

One method for providing real-time information about user-defined locations includes the steps of storing at least one user-defined geographic location in a radio memory and receiving signals including information about a plurality of geographic locations. Once received, the plurality of geographic locations are compared with the user-defined geographic location(s), and a user is presented with the information about the geographic location.

### BRIEF DESCRIPTION OF THE DRAWINGS

The present invention will hereinafter be described in conjunction with the following drawing figures, wherein like numerals denote like elements, and

FIG. 1 is a logical block diagram of a portion of one exemplary embodiment of a radio for providing real-time information about user-defined geographic locations;

FIG. 2 is a table illustrating one embodiment of a filter file stored in a memory of the radio of FIG. 1;

FIG. 3 illustrates an exemplary embodiment of real-time information about user-defined geographic locations shown on a display of the radio of FIG. 1; and

FIG. 4 illustrates an exemplary embodiment of a webpage for generating the filter file of FIG. 2.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

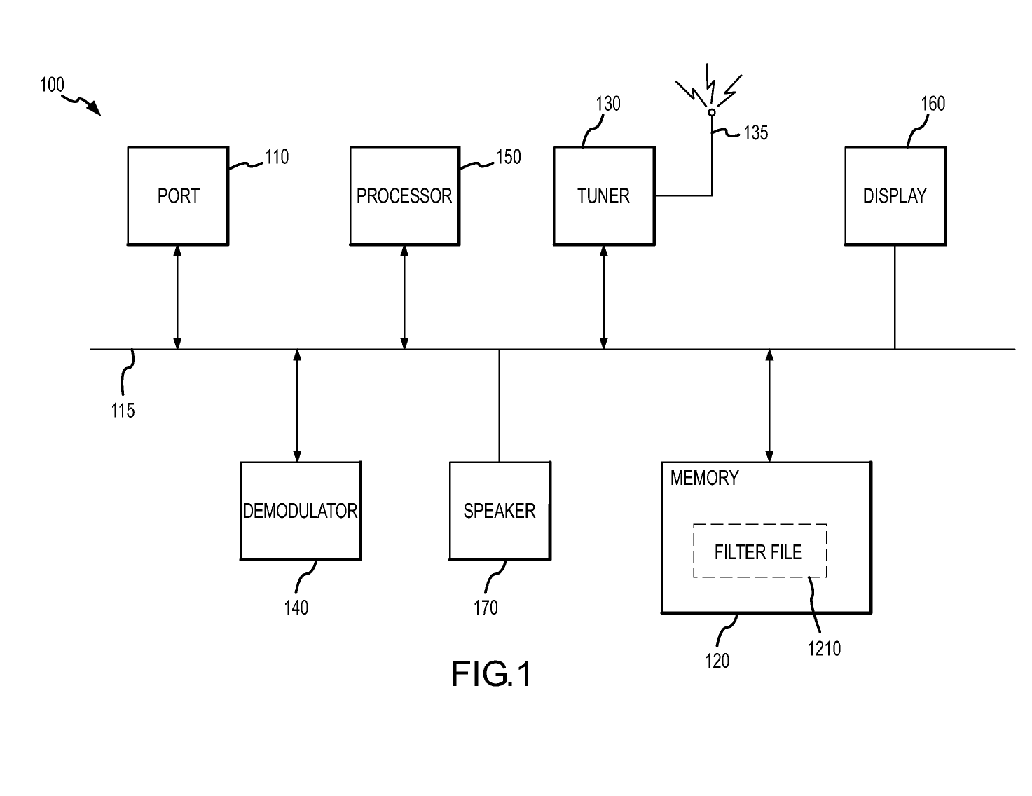

FIG. 1 is a logical block diagram of a portion of one exemplary embodiment of a radio 100 that provides real-time information about geographic locations defined by a user. Radio 100 includes a port 110 (e.g., a Universal Serial Bus (USB) port, a FireWire (IEEE 1394) port, an Ethernet (IEEE 802.3) port, a wireless (IEEE 802.11) port, a Bluetooth® port, a card reader port, a jump drive, and the like) coupled to a bus 115.

Bus 115 may be a physical interface between at least two integrated circuits (not shown), electronic control units (not shown), or similar devices. Furthermore, bus 115 may be a logical interface within a single integrated circuit, electronic control unit, or similar device.

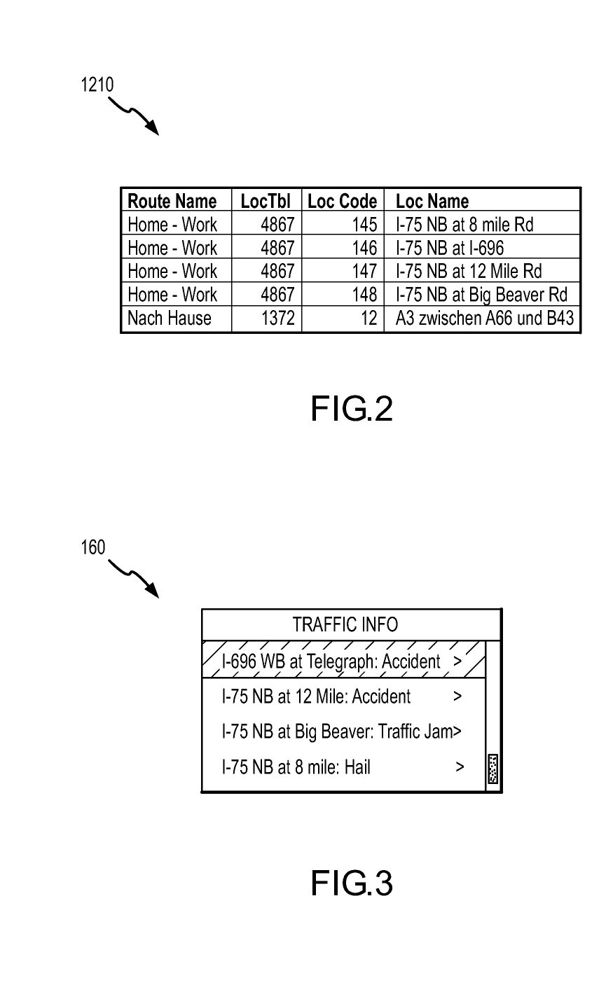

Radio 100 also includes a memory 120 coupled to bus 115. Memory 120 is configured to store a filter file 1210 (see FIG. 2) of one or more geographic locations defined by a user. In the exemplary embodiment illustrated in FIG. 2, filter file 1210 includes the name of each geographic location chosen by the user, a location code for each geographic location, a location table where the location code is further organized, and a route name for multiple geographic locations grouped by the user, although various other embodiments of filter file 1210 may include a fewer number or a greater number of rows and/or columns containing a variety of data.

As discussed, filter file 1210 includes one or more geographic locations specified by the user, which may be, for example, an intersection of two or more roadways, a specific point on a roadway (e.g., an off ramp along a northbound highway), an address, a landmark, or other descriptor. Each geographic location is represented by a location code, which may be further organized into one or more location tables by country, state/province, region/county, city, and/or the like.

Two or more geographic locations may be combined in a data table within filter file 1210 to form a route. Furthermore, filter file 1210 may include multiple data tables representing multiple user-defined routes having one or more geographic locations therein. For example, one table may include multiple geographic locations forming a route from the user's home to a destination where the user frequency travels (e.g., work, school, friend/relative's home, etc.). Another table may include the same geographic locations, but for the opposite side of the roadway. That is, the first table may include roadway information (e.g., traffic conditions) for the northbound or eastbound lanes, while the second table may include information for the southbound or westbound lanes.

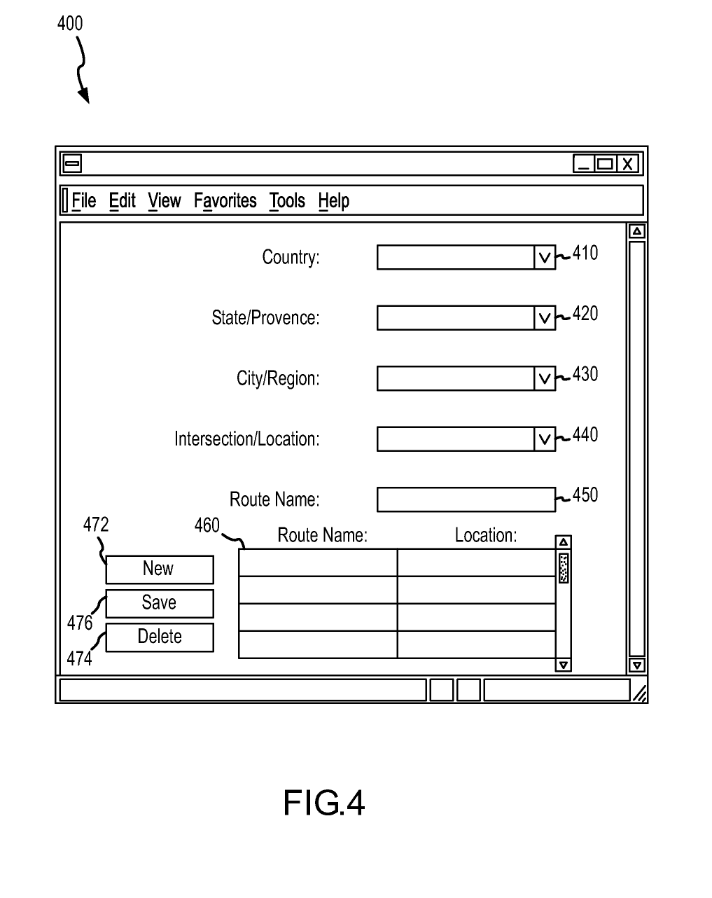

Filter file 1210 is created by the user in an external computing device (e.g., a personal computer, a cellular telephone, a hand-held computing device (e.g., a personal digital assistant (PDA), a Palm® device, etc.), and the like (not shown)), and transferred to memory 120 via port 110 and bus 115. Filter file 1210 may be transmitted to radio 100 using, for example, a temporary media (e.g. a flash memory, an optical memory, a smartcard, etc.), direct communication (e.g., wired or wireless) from the computing device that enabled the user to create and/or modify (discussed below with reference to FIG. 4) filter file 1210, or an intermediate computing device (e.g., a cellular telephone, a hand-held computing device, a notebook computer, and the like).

Since filter file 1210 may store a relatively small number of user-defined geographic locations, memory 120 requires less memory to store filter file 1210 than the required amount of memory needed in traditional navigation systems. For example, when filter file 1210 is a text-only file, filter file 1210 includes about 1.5 kB to about 10 kB of data. When filter file 1210 is an audio-only file (e.g., includes wave files), filter file 1210 includes about 100 kB to about 960 kB of data. When filter file 1210 includes both text and audio files, filter file 1210 includes less than about 1 MB of data.

Referring again to FIG. 1, radio 100 also includes a tuner 130 (e.g., a digital frequency modulated (FM) tuner, an XM satellite radio tuner, a Sirius satellite radio tuner, High Definition (HD) radio tuner, a Digital Radio Mondial (DRM) tuner, and the like) coupled to bus 115 and to an antenna 135. Tuner 130 is configured to receive signals (e.g., FM signals, digital signals, satellite radio signals (e.g., XM satellite radio signals, Sirius satellite radio signal, and the like), HD radio signals, DRM signals, and the like signal via antenna 135) having information (e.g., traffic, weather, etc.) about multiple geographic locations from an external signal source (not shown). The signals received by tuner 130 are demodulated (e.g., via a demodulator 140) and transmitted (via bus 115) to memory 120 and/or a separate memory (not shown) for at least temporary storage.

A processor 150 configured to compare each geographic location in the received signals to each geographic location in filter file 1210 is also coupled to bus 115. Processor 150 disseminates the information for each geographic location in the signals that matches a geographic location in filter file 1210 to the user, and discards each geographic location that does not match a geographic location in filter file 1210.

The information about the geographic locations in filter file 1210 may be disseminated (see e.g., FIG. 3) to the user via a display 160 (e.g., an LED display, a digital display, and the like) coupled to bus 115. The information about the geographic locations in filter file 1210 may additionally be disseminated audibly to the user via a speaker 170 coupled to bus 115.

As illustrated in the exemplary embodiment of FIG. 3, display 160 lists the name of one or more geographic locations and provides the information (e.g., traffic conditions, weather conditions, etc.) pertaining to the geographic location(s). The information may be updated and displayed on a continual, substantially continual, periodic, or batch basis.

Although FIG. 3 illustrates the name and information for four geographic locations, various embodiments contemplate that display 160 may include a fewer number or a greater number of geographic locations. Similarly, display 160 may display more information about the geographic location(s), and/or may use symbols, colors, or other graphics to represent the information about the geographic location(s).

FIG. 4 illustrates an exemplary embodiment of a webpage 400 for generating filter file 1210 on the external computing device. Webpage 400 includes a pull down menu 410 to enable a user to input the country of a chosen geographic location, a pull down menu 420 to input the state or province of the geographic location, a pull down menu 430 to input the city or region of the geographic region, and a pull down menu 440 of the intersection, location, or landmark of the geographic location.

A text field 450 is also included to enable the user to name a route of grouped geographic locations. The route name and geographic location are displayed in a table 460, and the user may create, modify, and save the geographic location(s) in filter file 1210 using one or more buttons (e.g., new button 472, delete button 474, and save button 476). Filter file 1210 may be saved to an internal or removable memory (e.g., flash/optical memory (not shown)) of the external computing device, which is subsequently transferred to radio 100.

Although FIG. 4 illustrates a webpage for creating filter file 1210, filter file 1210 may be created using non-web-based programs stored on the external computing device. Furthermore, webpage 400 is included to illustrate one possible method for creating filter file 1210; however, one skilled in the art will recognize that webpage 400 and/or filter file 1210 may include a fewer number or a greater number of input options and may include an infinite number of configurations.

Since the user chooses the geographic location(s) in filter file 1210, the present location of radio 100 is not material to the dissemination of the information to the user. Accordingly, radio 100 does not require a global positioning system (GPS) or a map, although one or both may be included.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description provides those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

I claim:

1. A radio, comprising:
a memory configured to store a data file representing at least one geographic location defined by a user;
a receiver configured to receive signals including real-time information about a plurality of geographic locations;
a processor coupled to the memory and the receiver, and configured to compare each of the plurality of geographic locations to the at least one geographic location; and
a communication device that conveys the information about the at least one geographic location to the user.

2. The radio of claim 1, wherein the communication device is one of a visual display and an audio speaker.

3. The radio of claim 1, wherein the data file includes less than 1 MB of data.

4. The radio of claim 1, wherein the memory is one of a removable magnetic memory device, a removable optical memory device, and a removable solid-state memory device.

5. The radio of claim 1, wherein the information represents one of a traffic condition and a weather condition.

6. A system for providing real-time information about user-defined locations, comprising:
a computing device configured to receive and store data from a user in a data file defining at least one geographic location; and
a radio configured to receive the data file, the radio including:
a memory configured to store the data file;
a receiver configured to receive signals including real-time information about a plurality of geographic locations;
a processor coupled to the memory and the receiver, and configured to compare each of the plurality of geographic locations to the at least one geographic location in the data file; and
a communication device that conveys the information about the least one geographic location to the user.

7. The system of claim 6, wherein the computing device is configured to store the data file defining the at least one geographic location in a removable memory and the radio is configured to receive the removable memory.

8. The system of claim 6, wherein the computing device is configured to transmit the data file defining the at least one geographic location to an external device.

9. The system of claim 6, wherein the computing device is configured to transmit the data file defining the at least one geographic location directly to the radio.

10. The system of claim 6, wherein the computing device is configured to transmit the data file defining the at least one geographic location to one of a cellular telephone, a personal digital assistant, and a portable computing device, and the radio is configured to receive the data file from the one of the cellular telephone, the personal digital assistant, and the portable computing device.

11. The radio of claim 6, wherein the communication device is one of a visual display and an audio speaker.

12. The radio of claim 6, wherein the information represents one of a traffic condition and a weather condition.

13. The radio of claim 6, wherein the data file defining the at least one geographic location includes less than about 1 MB of data.

14. The radio of claim 6, wherein the memory is one of a removable magnetic memory device, a removable optical memory device, and a removable solid-state memory device.

15. A method for providing real-time information about user-defined locations comprising the steps of:
storing at least one user-defined geographic location in a radio memory;
receiving signals including information about a plurality of geographic locations;
comparing each of the plurality of geographic locations with the at least one user-defined geographic location; and
presenting a user with the information about the at least one user-defined geographic location.

16. The method of claim 15, further comprising the step of receiving the at least one user-defined geographic location from a removable storage medium.

17. The method of claim 16, wherein the receiving step comprises the step of receiving the at least one user-defined geographic location from one of a flash drive, an optical drive, a smartcard, and a jump drive.

18. The method of claim 15, further comprising the step of receiving the at least one user-defined geographic location from an external computing device.

19. The method of claim 18, wherein the external computing device is one of a cellular telephone, a portable computing device, and a personal digital assistant.

20. The method of claim 15, wherein the presenting step comprises the step of presenting one of a traffic condition and a weather condition to the user.
